(19) United States
(12) Patent Application Publication
(10) Pub. No.: US 2025/0121391 A1
(43) Pub. Date: Apr. 17, 2025

(54) Shield for Cleaning a Tire of a Vehicle

(71) Applicant: Brett Kevin Kiser, Sr., Bessemer City, NC (US)

(72) Inventor: Brett Kevin Kiser, Sr., Bessemer City, NC (US)

(21) Appl. No.: 18/379,953

(22) Filed: Oct. 13, 2023

(51) Int. Cl. B05B 12/30

(52) U.S. Cl. CPC B05B 12/30

(57) ABSTRACT

A shield to protect a wheel during cleaning. The shield includes a body with a circular shape with a first side, a second side, a sidewall. The body comprises a center point. A handle has first and second openings that extend through the body. The first and second openings are spaced an equal distance away from the center point. The body is flat and the first side and the second side are parallel.

### TECHNICAL FIELD

The present application is directed to a device for use when cleaning a tire on a vehicle and, more specifically, to a shield configured to held by a user and sized to extend over the wheel when cleaning the tire.

### BACKGROUND

Tires are mounted to wheels of a vehicle and are a visual focal point of a vehicle. To approve the overall appearance of the vehicle, the tires are often cleaned using soap and water to remove dirt and other debris that accumulates during driving. During washing, a spray of water is applied to the tires. After washing, a spray is often applied to the tires to provide a protective coating and/or shiny finish.

It is often necessary to prevent the spray from contacting the wheels during the cleaning process. A shield can be positioned over the wheel during the washing to prevent contact with the spray. However, existing shields have numerous drawbacks.

One issue is vehicles are usually cleaned on driveways, parking lots, or other like surfaces. Shields can be left on the surfaces and misplaced during the cleaning. This can result in the shield being run over by the vehicle after the cleaning is complete. This can cause damage to the vehicle, such as puncturing the tire or potentially damaging a rim of the wheel. Additionally or alternatively, the shield can be damaged. The shield can be damaged to an extent that it can no longer be used in the future.

Another issue is the difficulty in properly positioning the shield during use. Because the user is normally positioned in front of the wheel when cleaning the tire, the shield can be positioned improperly resulting in the one or more sections of the wheel being exposed during the washing. The shields can include complicated handles that are grasped by the user during use. The handles can make it difficult to hold and place the shield in the center of the wheel.

### SUMMARY

One aspect is directed to a shield to protect a wheel during cleaning. The shield comprises a body with a circular shape with a first side, a second side, a sidewall, and the body comprises a center point. A handle comprising first and second openings extend through the body with the first and second openings being spaced an equal distance away from the center point. The body is flat and the first side and the second side are parallel.

In another aspect, a thickness of the body measured between the first side and the second side is constant throughout the body.

In another aspect, a first axis divides the body into first equal halves and a second axis that is perpendicular to the first axis divides the body into second equal halves with the first equal halves being mirrored images and the second equal halves being mirrored images.

In another aspect, the first opening and the second opening have identical shapes and sizes.

In another aspect, the first opening and second opening extend through the body and a remainder of the body is solid.

In another aspect, edges of the first opening and the second opening are perpendicular to the first side and the second side of the body.

One aspect is directed to a shield to protect a wheel during cleaning. The shield comprises a body with a flat and circular shape with a first side, an opposing second side, and a center point. A first opening extends through the body. A second opening extends through the body and is spaced away from the first opening. The first opening and the second opening are positioned on opposing sides of the center point. The shield is symmetrical about a first axis that extends through the center point. The shield is symmetrical about a second axis that extends through the center point and is perpendicular to the first axis.

In another aspect, the first opening and the second opening form a handle for grasping the body.

In another aspect, the first and second openings are spaced an equal distance away from the center point.

In another aspect, the first side and the second side are parallel.

In another aspect, a thickness of the body measured between the first side and the second side is constant throughout the body.

In another aspect, a first pair of mirrored images sides are formed at the first axis and a second pair of mirrored images sides are formed at the second axis.

In another aspect, the first opening and the second opening have identical shapes and sizes.

In another aspect, the first opening and second opening extend through the body and a remainder of the body is solid.

In another aspect, edges of the first opening and the second opening are perpendicular to the first side and the second side of the body.

One aspect is directed to a method of cleaning a tire of a vehicle. The method comprises: grasping a central section of a shield that is formed between first and second openings in a body of the shield: positioning a flat first side of the shield outward away from the vehicle and a flat second side of the shield inward towards the vehicle: visually aligning a center point of the shield with a center point of the tire with the center point of the shield exposed and positioned between the first and second openings; aligning a sidewall of the shield with an inner edge of the tire; and applying a spray to the tire while the shield is positioned over a wheel of the vehicle.

In another aspect, the method further comprises contacting the flat first side of the shield against the tire.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of a shield to clean a tire of a vehicle.

FIG. 2 is a side view of a shield.

FIG. 3 is a front view of a shield.

FIG. 4 is a front view of a shield positioned over a wheel of a vehicle and within a center of a tire.

FIG. 5 is a flowchart diagram of a method of cleaning a tire of a vehicle.

### DETAILED DESCRIPTION

The present application is directed to a shield configured to be positioned over a wheel of a vehicle. The shield is sized to extend over the central section of the wheel within the tire. The shield protects the wheel components such as the brakes from being sprayed which could affect their proper functioning. The shield also prevents the wheel from being sprayed which could cause the wheels to have an inferior appearance. The shield is configured to be held by one hand of a user to free the other hand to apply the spray. The shield is further durable and able to withstand various forces.

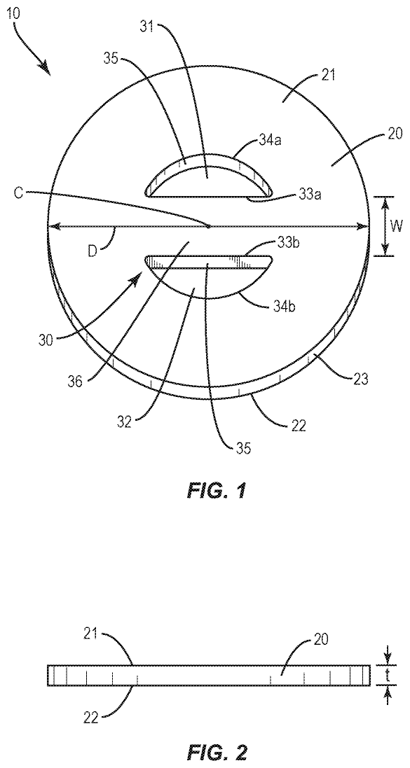

FIG. 1 illustrates a shield 10 configured to be positioned over a wheel of a vehicle. The shield includes a flat body 20 with a first side 21 and opposing second side 22. A sidewall 23 extends between the first side 21 and the second side 22. The body 20 has a circular shape with a constant radius R about the center point C.

As illustrated in FIG. 2, the body 20 is flat. Each of the first side 21 and the second side 22 are flat. The two sides 21, 22 are aligned parallel to one another. The body 20 has a thickness t measured between the two sides 21, 22. The thickness t is constant throughout the body 21. In one example, the thickness is ⅛ of an inch (0.125″). The sidewall 23 is perpendicular to each of the two sides 21, 22. In one example, the body 20 is constructed from polymer plastic. This material provides for the body 20 to be rigid to maintain the shape when held by the user. This material also does not degrade or otherwise become damaged when exposed to water and cleaning materials. The material is also light-weight allowing for the body 20 to be held by the user with one hand during vehicle cleaning.

The body 20 can include various sizes. Examples include diameters of 17.5 inches, 18.5 inches, 19.5 inches, and 21.5 inches.

The shield 10 includes a handle 30 configured to be held by the user. The handle 30 includes openings 31, 32 that extend through the body 20. The openings 31, 32 are positioned on opposing sides of the center point P. Edges 35 of the openings 31, 32 are perpendicular to the first and second sides 21, 22. In some examples, each of the openings 31, 32 includes the same shape and size. This provides for the shield to be used in the same manner when in different rotational orientations. In some examples, the openings 31, 32 include an inner edge 33 that is positioned towards the center point C and an outer edge 34. In some examples, the inner edges 33 are flat with other examples having scallops to accommodate the individual fingers of the user.

The inner edges 33 of the openings 31, 32 are spaced apart by a central section 36. The central section 36 includes the center point P and is positioned between the inner edges 33. The central section 36 has a width W measured between the inner edges 33. The width W is sized to be grasped by a user's hand. In use, the user places one or more of their fingers in a first one of the openings 31, 32 and their thumb in the other opening 31, 32. The user then squeezes the central section 36 to maintain their grip on the shield 10. The width W can include various sizes with one example being 3 inches.

The two openings 31, 32 are spaced away from the center point P. This provides for the center point P to be exposed and uncovered. This provides for a visual target to be used when aligning the shield with the wheel of the vehicle. The center point P is aligned with the center point of the wheel. The two openings 31,32 on opposing sides of the center point P also provide for the shield 10 to be oriented at different rotational positions when in use.

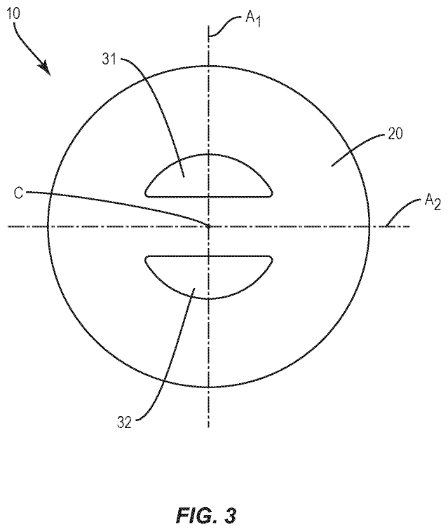

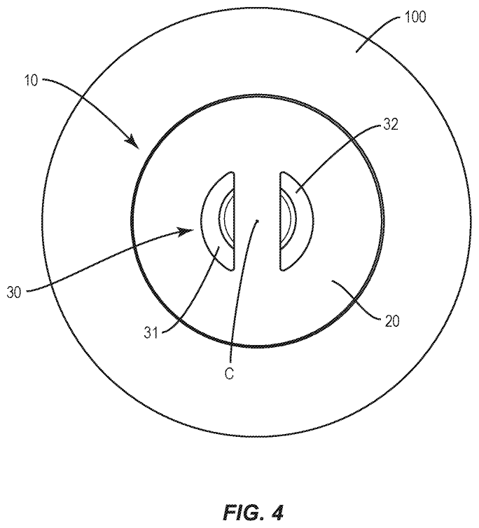

As illustrated in FIG. 3, the shield 10 has a uniform shape. A first axis A1 divides the shield 10 along a first plane into two equal halves (e.g., left and right halves). A second axis A2 is perpendicular to the first axis A1 and divides the shield 10 into two equal halves in a second plane (e.g., upper and lower halves). The shield 10 is symmetrical about each axis A1 and A2. The corresponding halves are also mirror images of each other.

FIG. 4 illustrates the shield 10 aligned with a tire 100 of a vehicle. The shield 10 is centered within the tire 100 and extends over the wheel and brake components. In one example, the shield 10 is sized to extend over the rims of the wheel. The center point P is exposed to be visually aligned with the center of the tire 100. The openings 31, 32 of the handle 30 are positioned to be grasped by a user with one handle while cleaning the tire 100.

The flat shape of the body 20 prevents damage in the event the shield is run over by the vehicle. The body 20 is constructed to withstand the forces applied by the vehicle if this were to occur. In some examples, the flat edges 35 of the openings 31, 32 further provide for the body 20 to withstand the forces and not be damaged when run over by the vehicle. Conversely, a design with an angled (non-perpendicular) orientation could be damaged as the effective thickness at the handles is less and susceptible to being damaged. The flat shape also provides for the shield 10 to be positioned in close proximity to the wheel. In one example, the flat back side provides for placing it directly against the wheel.

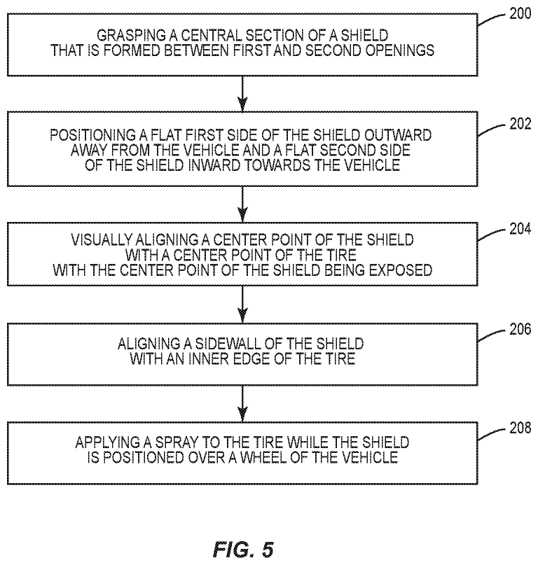

FIG. 5 illustrates a method of cleaning a tire of a vehicle. The method includes grasping a central section of a shield 10 that is formed between first and second openings 31, 32 in a body 20 of the shield 10 (block 200). A flat first side of the shield 10 is positioned outward away from the vehicle and a flat second side of the shield inward towards the vehicle (block 202). A center point of the shield 10 is visually aligned with a center point of the tire with the center point of the shield 10 exposed and positioned between the first and second openings 31, 32 (block 204). A sidewall 23 of the shield 10 is aligned with an inner edge of the tire (block 206). A spray is applied to the tire while the shield 10 is positioned over a wheel of the vehicle (block 208).

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A shield to protect a wheel during cleaning, the shield comprising:
a body comprising a circular shape with a first side, a second side, and a sidewall, the body comprising a center point;
a handle comprising first and second openings that extend through the body, the first and second openings being spaced an equal distance away from the center point; and
wherein the body is flat and the first side and the second side are parallel.

2. The shield of claim 1, wherein a thickness of the body measured between the first side and the second side is constant throughout the body.

3. The shield of claim 1, further comprising a first axis that divides the body into first equal halves and a second axis that is perpendicular to the first axis and that divides the body into second equal halves, the first equal halves being mirrored images and the second equal halves being mirrored images.

4. The shield of claim 1, wherein the first opening and the second opening have identical shapes and sizes.

5. The shield of claim 1, wherein the first opening and second opening extend through the body and a remainder of the body is solid.

6. The shield of claim 1, wherein edges of the first opening and the second opening are perpendicular to the first side and the second side of the body.

7. A shield to protect a wheel during cleaning, the shield comprising:
a body with a flat and circular shape, the body comprising a first side and an opposing second side, the body further comprising a center point;
a first opening that extends through the body;
a second opening that extends through the body and is spaced away from the first opening;
wherein the first opening and the second opening are positioned on opposing sides of the center point;
wherein the shield is symmetrical about a first axis that extends through the center point;
wherein the shield is symmetrical about a second axis that extends through the center point and is perpendicular to the first axis.

8. The shield of claim 7, wherein the first opening and the second opening form a handle for grasping the body.

9. The shield of claim 7, wherein the first and second openings are spaced an equal distance away from the center point.

10. The shield of claim 7, wherein the first side and the second side are parallel.

11. The shield of claim 7, wherein a thickness of the body measured between the first side and the second side is constant throughout the body.

12. The shield of claim 7, further comprising a first pair of mirrored images sides formed at the first axis and a second pair of mirrored images sides formed at the second axis.

13. The shield of claim 7, wherein the first opening and the second opening have identical shapes and sizes.

14. The shield of claim 7, wherein the first opening and second opening extend through the body and a remainder of the body is solid.

15. The shield of claim 7, wherein edges of the first opening and the second opening are perpendicular to the first side and the second side of the body.

16. A method of cleaning a tire of a vehicle, the method comprising:
grasping a central section of a shield that is formed between first and second openings in a body of the shield;
positioning a flat first side of the shield outward away from the vehicle and a flat second side of the shield inward towards the vehicle;
visually aligning a center point of the shield with a center point of the tire with the center point of the shield exposed and positioned between the first and second openings;
aligning a sidewall of the shield with an inner edge of the tire; and
applying a spray to the tire while the shield is positioned over a wheel of the vehicle.

17. The method of claim 16, further comprising contacting the flat first side of the shield against the tire.
